(19) United States
(12) Patent Application Publication
(10) Pub. No.: US 2010/0181389 A1
(43) Pub. Date: Jul. 22, 2010

(54) Smell Producing and Outputting Device

(75) Inventors: Chien-Hong CHEN, Jhonghe City (TW); Tsung-Hsi PAI, Jhonghe City (TW); Tsung-Jen HUANG, Jhonghe City (TW); Wen-Hao HSIAO, Jhonghe City (TW); Ching-Tang PENG, Jhonghe City (TW)

Correspondence Address: Muncy, Geissler, Olds & Lowe, PLLC, 4000 Legato Road, Suite 310, FAIRFAX, VA, 22033, US

(73) Assignee: GVISION INCORPORATED, Jhonghe City (TW)

(21) Appl. No.: 12/421,426

(22) Filed: Apr. 9, 2009

(30) Foreign Application Priority Data
Jan. 22, 2009 (TW) 098102479

(51) Int. Cl. B05B 15/04

(52) U.S. Cl. 239/289

(57) ABSTRACT

A smell producing and outputting device capable of providing a certain smell correspondingly to a certain image or a certain sound is disclosed. The disclosed smell producing and outputting device comprises: an audio processing unit for detecting an image signal or a sound signal; and a smell producing and outputting unit including a smell storing reservoir, a compression part, a driving part, and an outside shell, wherein the smell storing reservoir, the compression part, the driving part are received by the outside shell, and the driving part is electrically connected with the audio processing unit. When a certain image signal or a certain sound signal is received by the audio processing unit, the audio processing unit outputs a driving signal to the driving part, for changing the position of the compression part. Thus, a smell is driven out from the smell producing and outputting unit and distributed in the atmosphere.

### BACKGROUND OF THE INVENTION

1. Field of the Invention

The present invention relates to smell producing and outputting device and, more particularly, to a smell producing and outputting device capable of providing a certain smell correspondingly to a certain image or a certain sound.

2. Description of Related Art

Currently, the conventional video player in the market, such as the display device for playing commercial advertisement, can only play image and sound. Therefore, when a commercial advertisement of a fried chicken is played by the conventional video player, the consumer can only see the out-looking of the fried chicken and the background music, the consumer cannot smell of the smell of the fried chicken at the same time. As a result, the effectiveness of the commercial advertisement played by the conventional video player is limited. On the other hand, the projector used in theater and the projector used in home can only project an image on a projecting screen, making the viewer can only see the image and the corresponding sound, the viewer cannot smell a certain smell when he or she sees a certain image or hears a certain sound. For example, when the viewer sees an image of a garden, he or she cannot smells the smell spread out from the flowers in the garden. Therefore, the viewer cannot feel himself or herself as being in the garden when the image of the garden is projected on the projecting screen.

Therefore, a smell producing and outputting device capable of providing a certain smell correspondingly to a certain image or a certain sound is required.

### SUMMARY OF THE INVENTION

The object of the present invention is to provide a smell producing and outputting device capable of providing a certain smell correspondingly to a certain image or a certain sound.

To achieve the object, the smell producing and outputting device of the present invention, adapted for producing a certain smell correspondingly to a certain image or a certain sound, comprises: an audio processing unit for detecting an image signal or a sound signal; and a smell producing and outputting unit, including a smell storing reservoir, a compression part, a driving part, and an outside shell, wherein the driving part is located on one side of the smell storing reservoir, and the smell storing reservoir is received by the compression part. Besides, the smell storing reservoir, the compression part, the driving part are received by the outside shell, and the driving part is electrically connected with the audio processing unit. When a certain image signal or a certain sound signal is received by the audio processing unit, the audio processing unit outputs a driving signal to the driving part, for making the compression part move from an original position to a compression position. Thus, a smell is driven out from the smell producing and outputting unit and distributed in the atmosphere.

Therefore, the audio processing unit of the smell producing and outputting device of the present invention continuously detects whether a certain image signal or a certain sound signal is received when it plays a video, and once the certain image signal or the certain sound signal is received, the audio processing unit outputs a driving signal to the driving part of the smell producing and outputting unit, for making the compression part thereof move from an “original position” to a “compression position”. Moreover, at the “compression position”, the condensed liquid having a certain smell and stored in the smell storing reservoir will be spread out and distributed in the atmosphere. As a result, the smell producing and outputting device of the present invention can provide a certain smell correspondingly to a certain image or a certain sound, and distribute the smell in the atmosphere.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view of the smell producing and outputting device according to one embodiment of the present invention.

FIG. 2 is a perspective view of the smell producing and outputting unit of the smell producing and outputting device according to one embodiment of the present invention.

FIG. 3 is a perspective view of the smell producing and outputting device according to other embodiment of the present invention.

FIG. 4 is a perspective view of the smell producing and outputting device according to another embodiment of the present invention.

### DETAILED DESCRIPTION OF THE PREFERRED EMBODIMENT

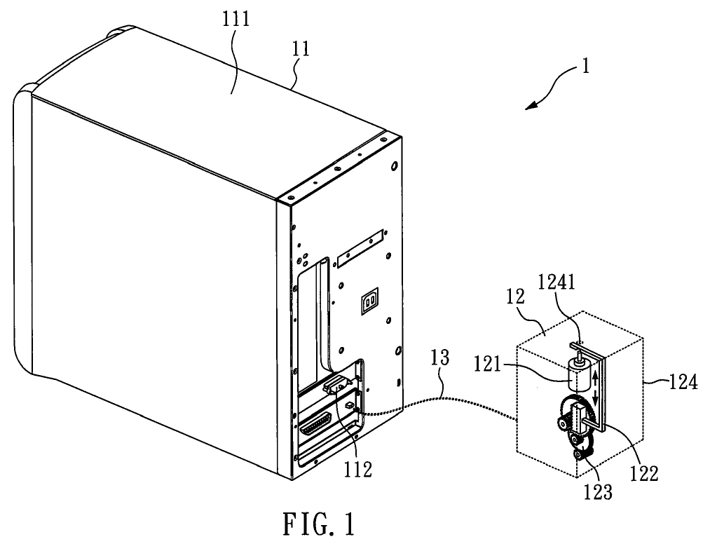

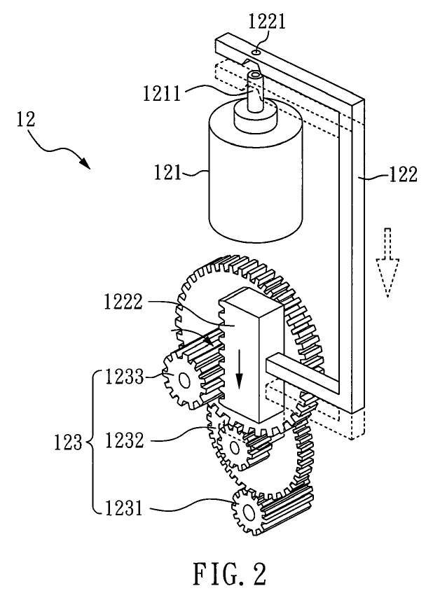

With reference to FIG. 1 and FIG. 2, the smell producing and outputting device 1 according to one embodiment of the present invention comprises: an audio processing unit 11 for detecting an image signal (not shown in the figure) or a sound signal (not shown in the figure), and a smell producing and outputting unit 12, wherein the audio processing unit 11 includes a case 111, and the smell producing and outputting unit 12 is located outside from the case 111. Besides, the smell producing and outputting unit 12 includes a smell storing reservoir 121, a compression part 122, a driving part 123, and an outside shell 124, wherein the smell storing reservoir 121, the compression part 122, and the driving part 123 are received by the outside shell 124.

Moreover, the case 111 includes an input/output interface part 112, and an RS-232 connecting wire 13 (it may also be a USB connecting wire or other kinds of connecting wire capable of transmitting signals) is electrically connected with the input/output interface part 112 and the smell producing and outputting unit 12, for transmitting a driving signal (not shown in the figure) from the audio processing unit 11, to the driving part 123 of the smell producing and outputting unit 12. In the present embodiment, the input/output interface part 112 is an RS-232 interface.

As shown in FIG. 2, the driving part 123 is located on one side of the smell storing reservoir 121, and the smell storing reservoir 121 is received by the compression part 122. Besides, the smell storing reservoir 121 includes an opening 1211, wherein a condensed liquid (not shown in the figure) having a certain smell is stored in the smell storing reservoir 121. Moreover, the compression part 122 includes a valve 1221 corresponding to the opening 1211 of the smell storing reservoir 121. The compression part 122 includes a pushing rack 1222 located below the smell storing reservoir 121, for pushing the smell storing reservoir 121 moving toward the valve 1221.

As shown in FIG. 1 and FIG. 2, the driving part 123 includes an active gear 1231, a first reduction gear 1232, and a second reduction gear 1233, wherein the first reduction gear 1232 engages with the active gear 1231 and the second reduction gear 1233, respectively. The second reduction gear 1233 then engages with the pushing rack 1222. Besides, the outside shell 124 includes an opening hole 1241 nearby the valve 1221 of the compression part 122.

In the present embodiment, the audio processing unit 11 includes an audio player software (not shown in the figure), for playing a movie (not shown in the figure) stored in the audio processing unit 11. During the playing process of the movie, the audio processing unit 11 continuously detects whether a certain image signal or a certain sound signal is received. Once the certain image signal or the certain sound signal is received, the audio processing unit 11 outputs a driving signal (not shown in the figure) to the driving part 123, for making the compression part 122 move from an “original position” (displayed by solid line) to a “compression position” (displayed by dash line), as shown in FIG. 2. At the “compression position”, the smell storing reservoir 121 is squeezed, making the condensed liquid (not shown in the figure) pass through the opening 1211, valve 1221 and the opening hole 1241 sequentially, and the smell is thus distributed in the atmosphere. As a result, the smell producing and outputting device of the present invention can provide a certain smell correspondingly to a certain image or a certain sound.

On the other hand, the information regarding the broadcasting time of the certain image signal (not shown in the figure) or the certain sound signal (not shown in the figure) is stored in the audio process unit 11. Once the audio process unit 11 starts to play the movie, a time counting process is also started by the audio process unit 11. The audio process unit 11 then outputs the driving signal (not shown in the figure) to the driving part 123, based on the information regarding the broadcasting time of the certain image signal (not shown in the figure) or the certain sound signal (not shown in the figure) and the result of the time counting process. Thus, a certain smell is output and distributed in the atmosphere at certain time.

Finally, after providing the certain smell for a certain time slot, such as 0.5 second, the driving part 123 of the smell producing and outputting unit 12 will move backwardly, making the compression part 122 move from the “compression position” (displayed by dash line) to the “original position” (displayed by solid line). Therefore, the smell producing and outputting unit 12 may be ready for receiving next driving signal, for providing a certain smell correspondingly to a certain image or a certain sound again.

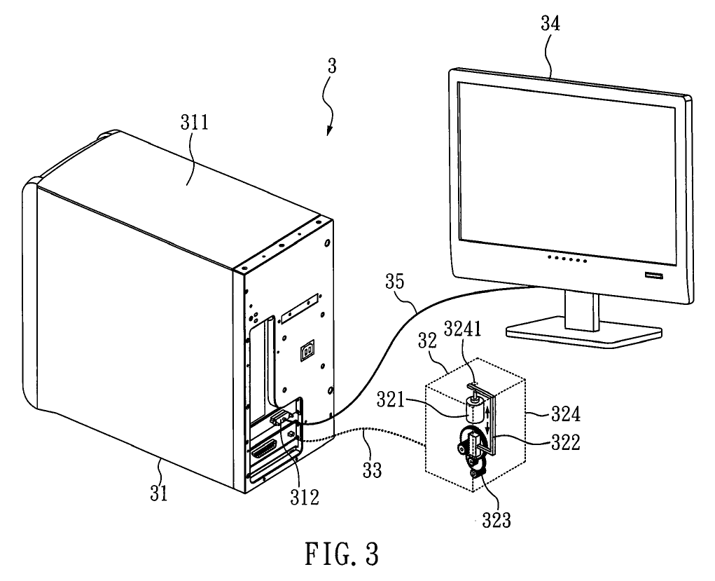

With reference to FIG. 3, the smell producing and outputting device 3 according to other embodiment of the present invention comprises: an audio processing unit 31 for detecting an image signal (not shown in the figure) or a sound signal (not shown in the figure), and a smell producing and outputting unit 32, wherein the audio processing unit 31 includes a case 311, and the smell producing and outputting unit 32 is located outside from the case 311. Besides, the smell producing and outputting unit 32 includes a smell storing reservoir 321, a compression part 322, a driving part 323, and an outside shell 324, wherein the smell storing reservoir 321, the compression part 322, and the driving part 323 are received by the outside shell 324 having an opening hole 3241.

Moreover, the case 311 includes an input/output interface part 312, and an RS-232 connecting wire 33 (it may also be a USB connecting wire or other kinds of connecting wire capable of transmitting signals) is electrically connected with the input/output interface part 312 and the smell producing and outputting unit 32, for transmitting a driving signal (not shown in the figure) from the audio processing unit 31, to the driving part 323 of the smell producing and outputting unit 32. As shown in FIG. 3, a liquid crystal display device 34 is electrically connected with the input/output interface part 312 through an image transmission wire 35, for receiving an image signal (not shown in the figure) from the audio processing unit 31. In the present embodiment, the input/output interface part 312 is an RS-232 interface.

In the present embodiment, the audio processing unit 31 includes an audio player software (not shown in the figure), for playing a movie (not shown in the figure) stored in the audio processing unit 31. During the playing process of the movie, the audio processing unit 31 continuously detects whether a certain image signal or a certain sound signal is received. Once the certain image signal or the certain sound signal is received, the audio processing unit 31 outputs a driving signal (not shown in the figure) to the driving part 323, for making the compression part 322 move from an “original position” (displayed by solid line) to a “compression position” (displayed by dash line). Therefore, the smell is thus distributed in the atmosphere through the opening hole 3241. As a result, the smell producing and outputting device of the present invention can provide a certain smell correspondingly to a certain image or a certain sound.

In the present embodiment, the information regarding the broadcasting time of the certain image signal (not shown in the figure) or the certain sound signal (not shown in the figure) is stored in the audio process unit 31. Once the audio process unit 31 starts to play the movie, a time counting process is also started by the audio process unit 31. The audio process unit 31 then outputs the driving signal (not shown in the figure) to the driving part 323, based on the information regarding the broadcasting time of the certain image signal (not shown in the figure) or the certain sound signal (not shown in the figure) and the result of the time counting process. Thus, a certain smell is output and distributed in the atmosphere at certain time.

Finally, after providing the certain smell for a certain time slot, such as 0.5 second, the driving part 323 of the smell producing and outputting unit 32 will move backwardly, making the compression part 322 move from the “compression position” (displayed by dash line) to the “original position” (displayed by solid line). Therefore, the smell producing and outputting unit 32 may be ready for receiving next driving signal, for providing a certain smell correspondingly to a certain image or a certain sound again.

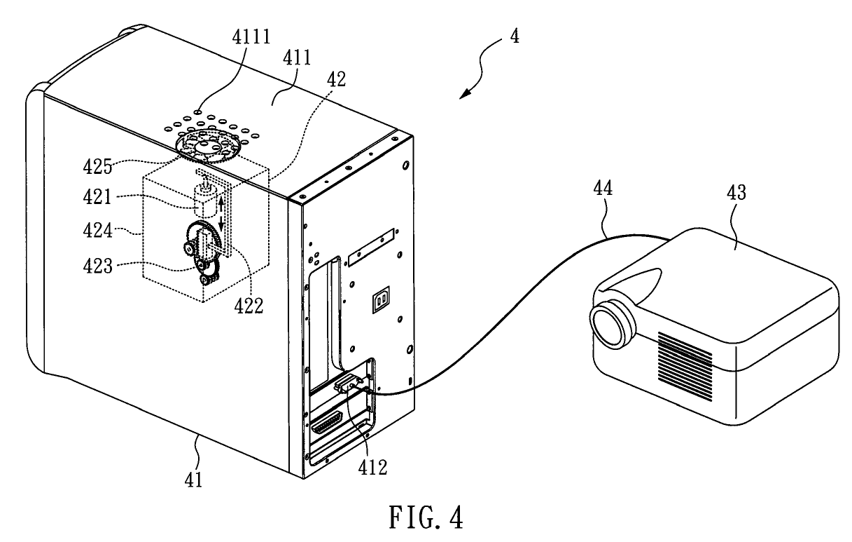

With reference to FIG. 4, the smell producing and outputting device 4 according to another embodiment of the present invention comprises: an audio processing unit 41 for detecting an image signal (not shown in the figure) or a sound signal (not shown in the figure), and a smell producing and outputting unit 42, wherein the audio processing unit 41 includes a case 411 having a opening hole 4111. Besides, the smell producing and outputting unit 42 is received in the case 411. Moreover, the smell producing and outputting unit 42 includes a smell storing reservoir 421, a compression part 422, a driving part 423, an outside shell 424, and a fan 425.

As shown in FIG. 4, the smell storing reservoir 421, the compression part 422, and the driving part 423 are received by the outside shell 424, while the fan 425 is located on the outside shell 424. On the other hand, the case 411 includes an input/output interface part 412, and a projector 43 is electrically connected with the input/output interface part 412 through an image transmission line 44, for receiving an image signal (not shown in the figure) from the audio processing unit 41.

In the present embodiment, the audio processing unit 41 includes an audio player software (not shown in the figure), for playing a movie (not shown in the figure) stored in the audio processing unit 41. During the playing process of the movie, the audio processing unit 41 continuously detects whether a certain image signal or a certain sound signal is received. Once the certain image signal or the certain sound signal is received, the audio processing unit 41 outputs a driving signal (not shown in the figure) to the driving part 423, for making the compression part 422 move from an “original position” (displayed by solid line) to a “compression position” (displayed by dash line). Therefore, the smell is thus distributed in the atmosphere through the opening hole 4111.

Moreover, as the driving signal (not shown in the figure) is output to the driving part 423, the audio processing unit 41 also outputs a starting signal (not shown in the figure) to the fan 425, making the fan 425 start rotating to improve the spread out speed of the smell. As a result, the smell producing and outputting device of the present invention can provide a certain smell correspondingly to a certain image or a certain sound.

In the present embodiment, the information regarding the broadcasting time of the certain image signal (not shown in the figure) or the certain sound signal (not shown in the figure) is stored in the audio process unit 41. Once the audio process unit 41 starts to play the movie, a time counting process is also started by the audio process unit 41. The audio process unit 41 then outputs the driving signal (not shown in the figure) to the driving part 423, based on the information regarding the broadcasting time of the certain image signal (not shown in the figure) or the certain sound signal (not shown in the figure) and the result of the time counting process. Thus, a certain smell is output and distributed in the atmosphere at certain time.

Finally, after providing the certain smell for a certain time slot, such as 0.5 second, the driving part 423 of the smell producing and outputting unit 42 will move backwardly, making the compression part 422 move from the “compression position” (displayed by dash line) to the “original position” (displayed by solid line). Therefore, the smell producing and outputting unit 42 may be ready for receiving next driving signal, for providing a certain smell correspondingly to a certain image or a certain sound again.

As described above, the audio processing unit of the smell producing and outputting device of the present invention continuously detects whether a certain image signal or a certain sound signal is received when it plays a video, and once the certain image signal or the certain sound signal is received, the audio processing unit outputs a driving signal to the driving part of the smell producing and outputting unit, for making the compression part thereof move from an “original position” to a “compression position”. Moreover, at the “compression position”, the condensed liquid having a certain smell and stored in the smell storing reservoir will be spread out and distributed in the atmosphere. As a result, the smell producing and outputting device of the present invention can provide a certain smell correspondingly to a certain image or a certain sound, and distribute the smell in the atmosphere.

Although the present invention has been explained in relation to its preferred embodiment, it is to be understood that many other possible modifications and variations can be made without departing from the scope of the invention as hereinafter claimed.

What is claimed is:

1. A smell producing and outputting device, adapted for producing a certain smell correspondingly to a certain image or a certain sound, comprising:
an audio processing unit, for detecting an image signal or a sound signal; and
a smell producing and outputting unit, including a smell storing reservoir, a compression part, a driving part, and an outside shell, the driving part is located on one side of the smell storing reservoir, and the smell storing reservoir is received by the compression part;
wherein the smell reservoir, the compression part, the driving part are received by the outside shell, and the driving part is electrically connected with the audio processing unit; when a certain image signal or a certain sound signal is received by the audio processing unit, the audio processing unit outputs a driving signal to the driving part, for making the compression part move from an original position to a compression position; thus, a smell is driven out from the smell producing and outputting unit and distributed in the atmosphere.

2. The smell producing and outputting device as claimed in claim 1, wherein the audio processing unit includes a case, and the smell producing and outputting unit is located outside from the case.

3. The smell producing and outputting device as claimed in claim 2, wherein the case includes an input/output interface part, and the smell producing and outputting unit is electrically connected with the audio processing unit through the input/output interface part.

4. The smell producing and outputting device as claimed in claim 1, wherein the audio processing unit includes a case, and the smell producing and outputting unit is received by the case.

5. The smell producing and outputting device as claimed in claim 4, wherein the case includes an input/output interface part, and the audio processing unit controls the image signal through the input/output interface part.

6. The smell producing and outputting device as claimed in claim 1, wherein the image signal is provided by a DVD player.

7. The smell producing and outputting device as claimed in claim 1, wherein the smell storing reservoir includes an opening.

8. The smell producing and outputting device as claimed in claim 7, wherein the compression part includes a valve corresponding to the opening.

9. The smell producing and outputting device as claimed in claim 7, wherein the outside shell includes an opening hole nearby the valve of the compression part.

10. The smell producing and outputting device as claimed in claim 1, wherein the smell producing and outputting unit further comprises a fan located on the outside shell.

11. The smell producing and outputting device as claimed in claim 8, wherein the compression part includes a pushing rack located below the smell storing reservoir, for pushing the smell storing reservoir moving toward the valve.

12. The smell producing and outputting device as claimed in claim 11, wherein the driving part includes an active gear, a first reduction gear, and a second reduction gear, the first reduction gear engages with the active gear and the second reduction gear, respectively; and the second reduction gear engages with the pushing rack.

13. The smell producing and outputting device as claimed in claim 1, wherein a condensed liquid having a certain smell is stored in the smell storing reservoir.

14. The smell producing and outputting device as claimed in claim 1, wherein the information regarding the broadcasting time of the certain image signal or the certain sound signal is stored in the audio process unit, and the audio process unit outputs the driving signal to the driving part at a certain time based on the information.

15. The smell producing and outputting device as claimed in claim 1, wherein the audio processing unit detects whether an identification tag is embedded in the image signal, and when the identification tag is detected by the audio processing unit, the driving signal is output to the driving part by the audio processing unit.

16. The smell producing and outputting device as claimed in claim 1, wherein a sound producing part is electrically connected with the audio processing unit.

17. The smell producing and outputting device as claimed in claim 16, wherein the sound producing part is a speaker.
